(19) United States
(12) Patent Application Publication
(10) Pub. No.: US 2024/0335968 A1
(43) Pub. Date: Oct. 10, 2024

(54) PERFORATING APPARATUS AND METHODS OF USE THEREOF

(71) Applicant: The Procter & Gamble Company, Cincinnati, OH (US)

(72) Inventors: Brian Christopher SCHWAMBERGER, Fairfield Township, OH (US); Steven James SCHROECK, Cincinnati, OH (US); Andre MELLIN, Amberley Village, OH (US)

(21) Appl. No.: 18/297,830

(22) Filed: Apr. 10, 2023

(51) Int. Cl. B26D 7/26

(52) U.S. Cl. CPC B26D 7/2614; B26D 2007/0012

(57) ABSTRACT

A perforating apparatus including: a blade support having a blade support assembly, where the blade support assembly includes: a clamp coupled to the blade support; a blade positioned between the clamp and an outer surface of the blade support; and a plurality of dampener members extending along at least a portion of a longitudinal length of the blade, where a first dampener member is positioned on a first side of the blade, where a second dampener member is positioned on a second side of the blade, and where the first side of the blade faces the blade support and the second side of the blade is opposite the first side of the blade. Also disclosed is a method for forming a line of weakness in a substrate. Also disclosed is a blade support having a corresponding blade support assembly.

### FIELD OF THE INVENTION

The present disclosure is directed to a perforating apparatus and methods for forming a line of weakness in a substrate.

### BACKGROUND OF THE INVENTION

Many substrates include or can include a line of weakness having one or more perforations to facilitate tearing of the substrate. The line of weakness may be created by advancing the substrate between two cutting surfaces such as a rotating blade that flexes against a stationary anvil. Some of these perforations may have a non-linear shape, i.e., a shape other than a straight line. It has been found that creating non-linear perforations may cause increased stress on the perforation blade, resulting in fatigue cracking and failure. Therefore, there remains a need to provide an apparatus and method for forming shaped perforations that avoids blade cracking and failure.

### SUMMARY OF THE INVENTION

In accordance with the present disclosure, a perforating apparatus is provided, the apparatus including: a blade support comprising a blade support assembly, where the blade support assembly includes: a clamp coupled to the blade support; a blade positioned between the clamp and an outer surface of the blade support; and a plurality of dampener members extending along at least a portion of a longitudinal length of the blade, where a first dampener member is positioned on a first side of the blade, where a second dampener member is positioned on a second side of the blade, and where the first side of the blade faces the blade support and the second side of the blade is opposite the first side of the blade.

In accordance with another aspect of the present disclosure, a method for forming a line of weakness in a substrate, the method including: providing a blade support, where the blade support includes a blade support assembly, the blade support assembly having a blade; positioning a first dampener member on a first side of the blade; positioning a second dampener member on a second side of the blade; applying, by a clamp coupled to the blade support, a pressure to the blade; providing an anvil roll, where the anvil roll includes an anvil support assembly, the anvil support assembly having at least one anvil; positioning the anvil roll adjacent to the blade support such that the anvil support assembly interacts with the blade support assembly; and feeding a web between the blade support assembly and the anvil support assembly such that the blade cooperates with the anvil to perforate the web and form the line of weakness, where the blade flexes in a direction of the first side of the blade when the blade support assembly and the anvil support assembly interact, and where the blade rebounds in a direction of the second side of the blade when the blade support assembly loses contact with the anvil support assembly.

In accordance with another aspect of the present disclosure, a blade support having a blade support assembly, the blade support assembly including: a clamp coupled to the blade support; a blade; and a dampener member having a first portion positioned on a first side of the blade and a second portion positioned on a second side of the blade, where the first side of the blade faces the blade support and the second side of the blade is opposite the first side of the blade.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements.

FIG. 1 is an isometric view of a perforating apparatus, in accordance with the present disclosure.

FIG. 2 is a detailed view of a portion of a blade support having a blade support assembly, in accordance with the present disclosure.

FIG. 3 is a detailed view of a portion of an anvil roll having an anvil support assembly, in accordance with the present disclosure.

FIG. 4 is a detailed side view of an interaction of the blade support assembly and the second surface, in accordance with the present disclosure.

FIGS. 5A and 5B are detailed side views of movement of a blade during the interaction of the blade support assembly and the second surface in a conventional perforating apparatus.

FIGS. 6A-6G are side views of exemplary blade support assemblies in accordance with the present disclosure.

FIGS. 7A-7D are top views of a blade and dampener members in accordance with the present disclosure.

FIG. 8 is a side view of a dampener member in accordance with the present disclosure.

FIG. 9 is a side view of a blade and dampener member in accordance with the present disclosure.

FIG. 10 is a flowchart illustrating a process for cutting a substrate in accordance with the present disclosure.

### DETAILED DESCRIPTION

The present disclosure relates to methods and apparatuses for forming lines of weakness in a substrate. As discussed below, a perforating apparatus comprising a blade support having a blade support assembly, in which the blade support assembly comprises a blade and a first dampener member or dampener member portion located on a first side of the blade, which faces the blade support, and a second dampener member or dampener member portion located on a second side of the blade, which is opposite the first side of the blade. The blade may flex and rebound during an interaction with the anvil as part of the perforation process. Conventional perforating apparatuses only include the first dampener member that is compressed during initial flexing of the blade. It is believed that adding a second dampener member will limit the rebound of the blade, thus reducing stresses on the bottom of the blade and extending the life of the blade.

“Machine Direction (MD),” as used herein is the direction of manufacture for a perforated substrate. The machine direction may be the direction in which a substrate is advanced through a perforating apparatus that may comprise an anvil roll and a blade support, as discussed below. The machine direction may be the direction in which a substrate travels while advancing between a blade and an anvil of a perforating apparatus.

“Cross Machine Direction” or “Cross Direction (CD),” as used herein is the direction substantially perpendicular to the machine direction. The cross-machine direction or cross direction may be substantially perpendicular to the direction in which a substrate is fed through a perforating apparatus. The cross-machine direction or cross direction may be the direction substantially perpendicular to the direction in which a substrate travels while advancing between a blade and an anvil.

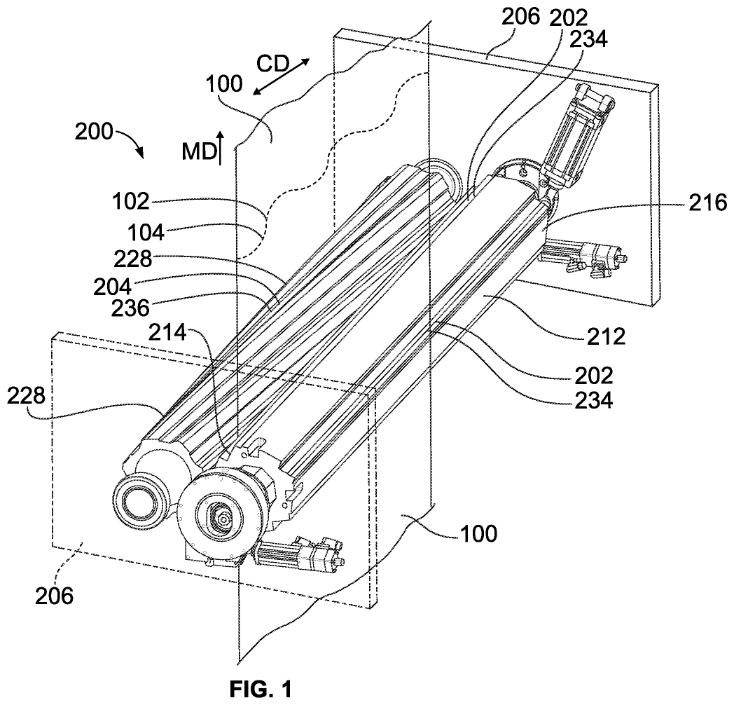

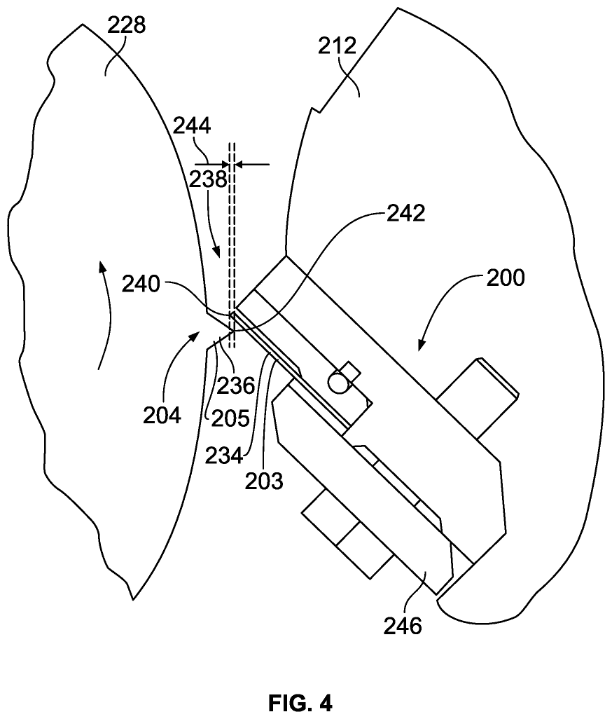

It is to be appreciated that various process and equipment configurations may be used to perforate a substrate 100. For example, FIGS. 1 and 4 illustrate one example of an apparatus 200 for perforating substrates 100 according to the present disclosure. In operation, the substrate 100 advances in a machine direction MD between a stationary blade support assembly 202 comprising a first cutting surface 203 and a rotating anvil support assembly 204 comprising a second cutting surface 205 that creates a plurality of perforations 102 in the substrate 100. As such, the perforations 102 imparted to the substrate 100 form a line of weakness 104. It is to be appreciated that the line of weakness 104 may be formed to extend in a straight line along the cross direction CD and/or may be formed to define an arcuate or non-linear line along the cross direction CD.

With reference to FIG. 1, the perforating apparatus 200 may include a frame 206 that rotatably supports a housing 208. The perforating apparatus 200 may also include a blade support 212 having a first end portion 214 and an opposing second end portion 216, wherein the housing 208 rotatably supports the first end portion 214. The blade support 212 may be adapted to rotate about an axis 218. The blade support 212 includes the blade support assembly 202. As shown in

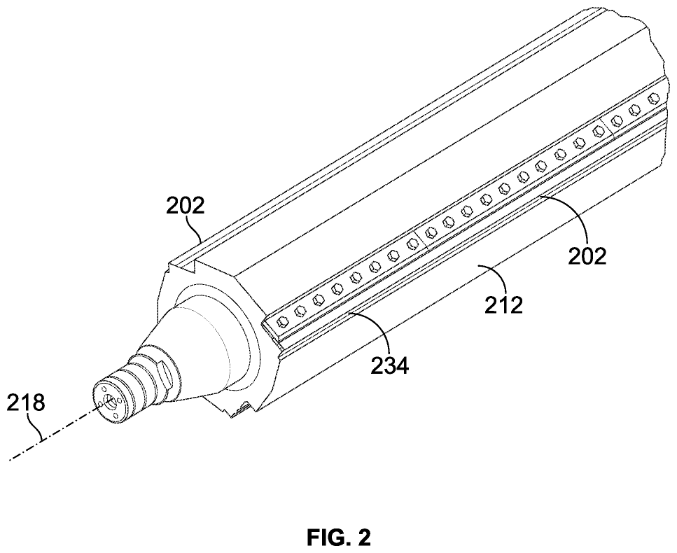

FIGS. 1 and 2, the blade support 212 may include one or more blade support assemblies 202 circumferentially spaced from each other about the axis 218. As such, the blade support 212 may be rotated about the second axis 218 to remove one blade support assembly 202 from service and place another blade support assembly 202 into service.

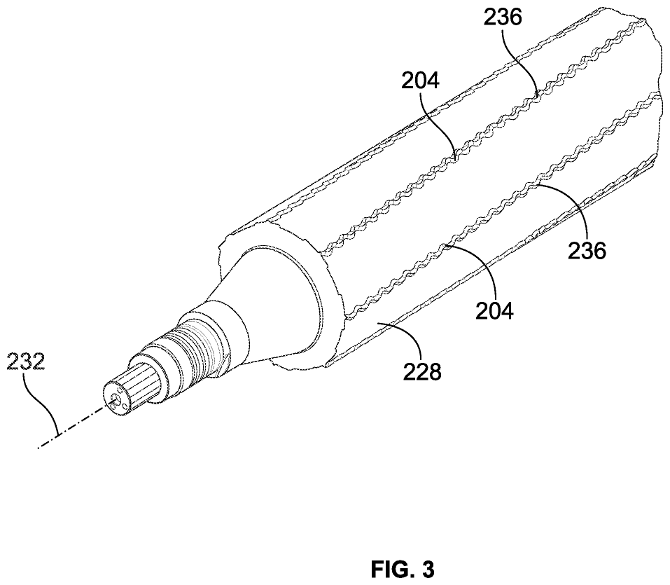

With continued reference to FIGS. 1 and 2, the perforating apparatus 200 may also include an anvil roll 228 rotatably supported by the frame 206. The anvil roll 228 may be positioned adjacent the blade support 212 and may be adapted to rotate about an axis 232. A shown in FIG. 3, the anvil roll 228 may include one or more anvil support assemblies 204 circumferentially spaced apart from each other around the axis 232. As such, the second cutting surface (not labeled; see FIG. 4) of the anvil support assembly 204 may be adapted to intermittently contact the first cutting surface (not labeled; see FIG. 4) of the blade support assembly 202 as the anvil roll 228 rotates about the axis 232 to create perforations 102 in advancing the substrates 100 to form lines of weakness 104. The perforating apparatuses 200 herein may be configured to produce rolled products having various qualities and characteristics, such as described for example, in U.S. Pat. Nos. 10,947,671, 11,008,709, 11,008,710, 11,180,892, and 11,268,243 and U.S. Patent Application Publication Nos. 2021/0180258 and 2021/0317613.

As discussed above with reference to FIG. 1, the substrate 100 advances between the blade support assembly 202 and the anvil support assembly 204. The blade support assembly 202 and the anvil support assembly 204 operate in contacting relationship to perforate the advancing substrate 100. It is to be appreciated that the blade support assembly 202 and the anvil support assembly 204 may be configured in various ways. For example, as shown in FIGS. 2-4, the blade support assembly 202 comprising the first cutting surface 203 may be configured as a blade 234 and the anvil support assembly 204 comprising the second cutting surface 205 may be configured as an anvil 236. During the perforating operation, the blade 234 may be held in a fixed position and the anvil 236 may rotate about the axis 232. A nip 238 is defined where the anvil 236 contacts the blade 234. In some configurations, the anvil support assembly 204 may be helically arranged on the anvil roll 228.

With continued reference to FIG. 4, the blade 234 may be positioned such that a distal edge 240 of the blade 234 overlaps a distal edge 242 of the anvil 236 by an overlap distance 244. The overlap distance 244 is measured from the distal edge 240 of the blade 234 to the distal edge 242 of the anvil 236 in a direction substantially parallel to the cross direction. This engagement forces the blade 234 to flex downward as it engages with the anvil 236.

It is to be appreciated that the blade support 212 may be configured in various ways. For example, the blade support 212 may be formed from metal, such as steel or a steel alloy, or from some other material as would be known to those skilled in the art to be suitable as a structural support of perforating equipment. The blade support 212 may be formed in a block shape, a cylindrical shape, or another shape to support a blade. The blade support 212 and blade 234 may be placed in a fixed, non-moveable, non-rotatable position during contacting relationship with the anvil 236. As previously described, the blade support 212 may be rotated about the second axis 218 to remove a particular blade 234 from service and fixed in a position so that a replacement blade 234 may be placed in contacting relationship with the anvil 236. As shown in FIG. 4, a portion of the blade 234 may be connected with the blade support 212 with a clamp 246. The clamp 246 and the blade support 212 may hold the blade 234 in position such that a portion of the blade 234 extends outward from the blade support 212 and is exposed for contact with the anvil 236. As such, the distal edge 240 and a first blade surface 248 may be exposed such that the anvil 236 operatively engages a portion of the first blade surface 248 and the distal edge 240 of the blade 234. The blade 234 may be held between the clamp 246 and the blade support 212 such that the blade 234 may deflect during operative engagement with the anvil 236, which may be referred to as a flex-rigid configuration. In some examples, the blade 234 interacts with the anvil 236 in a shearing action. The deflection and the inherent flexibility of the blade 234 may allow for relatively improved perforation reliability by being relatively more forgiving to slight differences in machine tolerances.

It is to be appreciated that the anvil roll 228 and anvil 236 may be configured in various ways. For example, the anvil 236 may be made from the same material or different material as the anvil roll 228. The anvil 236 may be made from a material that provides sufficient rigidity and life, strength, and wear resistance, such that the anvil 236 does not deflect or deflects minimally when engaging the blade 234 and can sustain relatively prolonged manufacturing run time. The anvil 236 may be made from metal such as steel, aluminum, or tungsten carbide. The anvil 236 may also be made from non-metal such as ceramic, carbon fiber, or hard plastic. It is also to be appreciated that the anvil 236 may be made from two or more different materials. In some configurations, the anvil 236 may extend in the cross direction CD along a straight line in the cross direction CD. In some configurations, the anvil 236 may include curved portions extending along the cross direction CD.

Although the blade support assembly 202 is described above in the form of a blade 234 and the anvil support assembly 204 is described above in the form of an anvil 236, it is to be appreciated that the perforating apparatus may be configured various ways, such as disclosed for example, in U.S. Patent Publication Nos. 2014/0366695; 2014/0366702; 2014/0370224; 2016/0271820; 2016/0271823; and 2016/0271824 and U.S. Provisional Patent Application Nos. 62/556,628; 62/556,633; and 62/556,720, all of which are incorporated by reference herein. In some configurations, the blade support assembly 202 may be configured as an anvil 236 and the anvil support assembly 204 may be configured as a blade 234. In some configurations, the blade support assembly 202 and the anvil support assembly 204 may both be configured as blades 234. In some configurations, the blade 234 may be configured with a continuous distal surface and the anvil may be configured with a plurality of anvil surfaces, also referred to herein as teeth, separated from each other by notches to define a discontinuous distal edge.

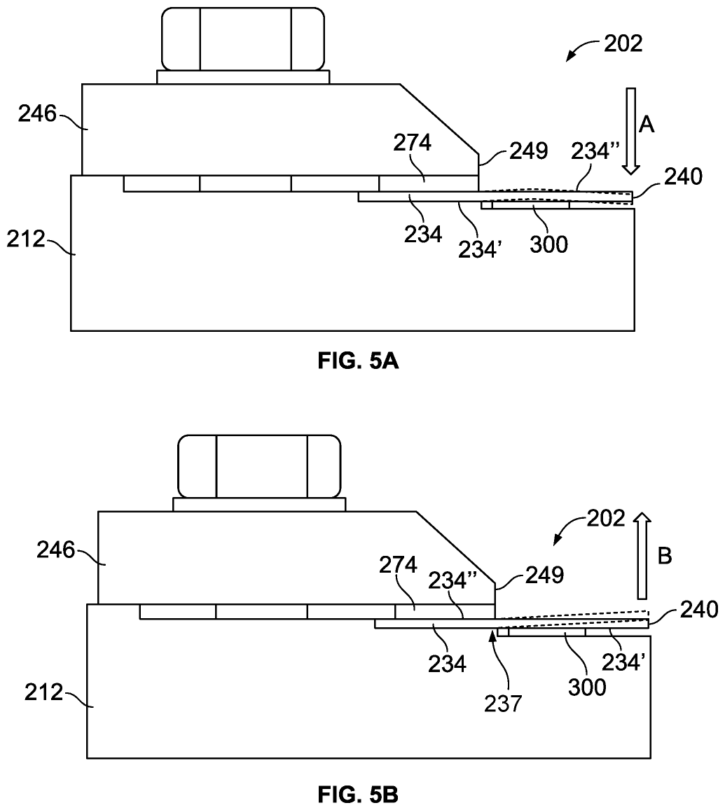

FIGS. 5A and 5B illustrate movement of a blade 234 during and after interaction with an anvil (not shown; see reference numeral 236 in FIG. 4) in a conventional perforating apparatus. The blade 234 prior to the interaction is indicated with solid lines, and the blade 234 during the interaction is indicated with dashed lines. A pressure distribution material 274 may be positioned between the clamp 246 and the blade 234, and a dampener member 300 may be positioned on a first side 234′ of the blade 234. As shown in FIG. 5A, interaction with the anvil causes a distal edge 240 of the blade 234 to flex in a direction of the first side 234′ of the blade 234, i.e.., towards the blade support 212, as shown with arrow A, while a middle portion of the blade 234 located over the dampener member 300 curves upward slightly, i.e., toward the second side 234″ of the blade 234 and away from the blade support 212. As shown in FIG. 5B, once the interaction ends, the distal end 240 of the blade 234 then rebounds in the direction of a second side 234″ of the blade 234, i.e.., away from the blade support 212, as shown with arrow B, which causes the middle portion of the blade 234 to move back toward the blade support 212.

When the blade 234 flexes toward the blade support 212 as shown in FIG. 5A, tensile stresses on the second side 234″ of the blade 234 near a distal edge 249 of a clamp 246 may be distributed across a larger area of the blade 234 due to the presence of the dampener member 300. However, during the rebound shown in FIG. 5B, tensile stresses are concentrated in a relatively small area on the first side 234′ of the blade 234. It was found that in the configuration shown in FIGS. 5A and 5B, cracks are initiated in the blade 234 at or near a flex point 237 adjacent to the distal edge 249 of the clamp 246. In particular, it was surprisingly found that cracks and fatigue failures are initiated at or near the flex point 237 on the first side 234′ of the blade 234. Without intending to be bound by theory, it is believed that the unrestricted rebound movement depicted in

FIG. 5B creates concentrated tensile stresses on the first surface 234′ of the blade 234 at the flex point 237 and that repeated application of these tensile stresses can lead to cracking and fatigue failure observed at this flex point 237.

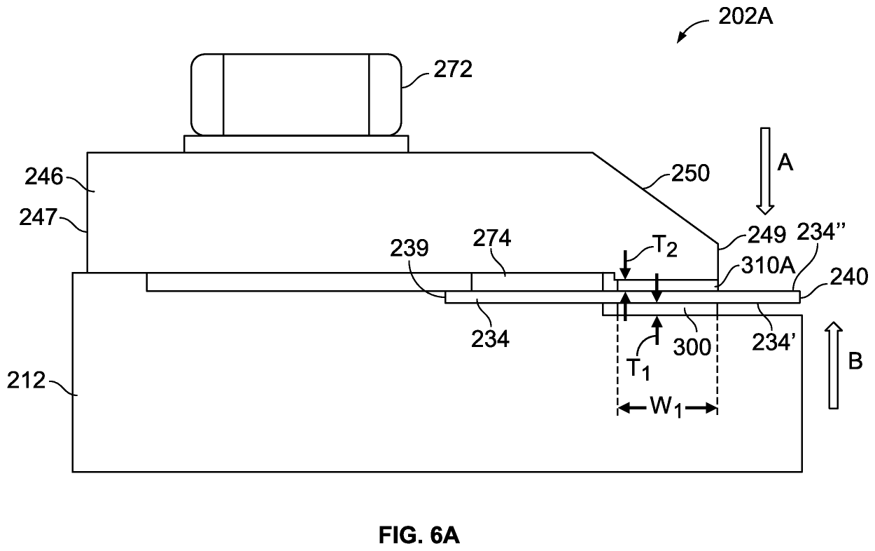

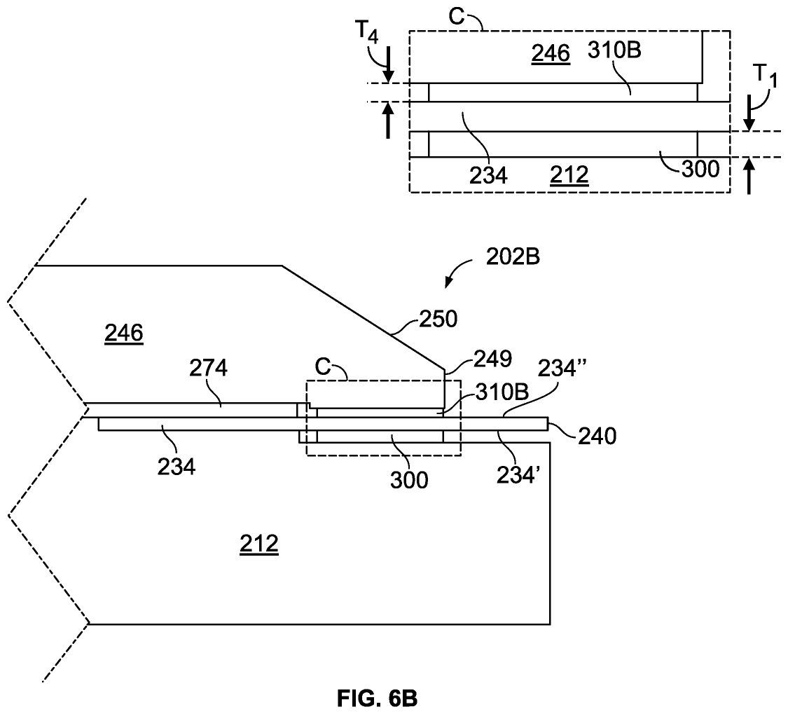

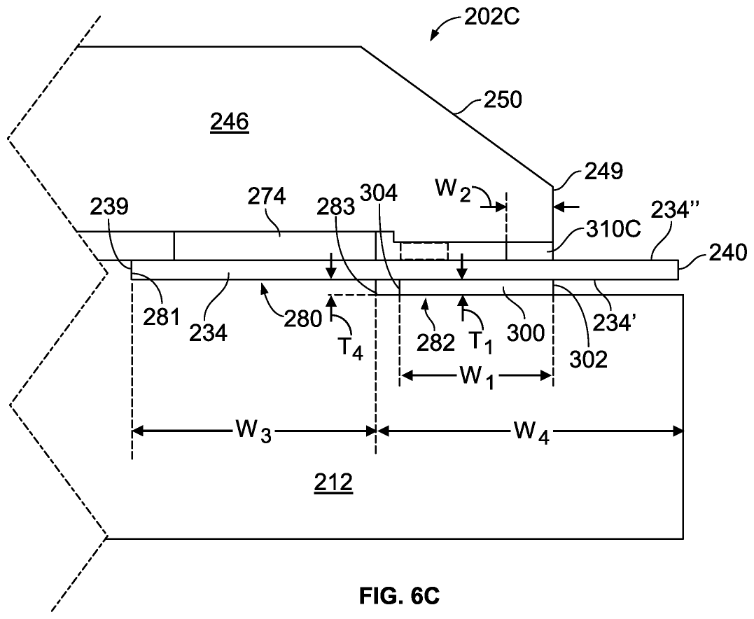

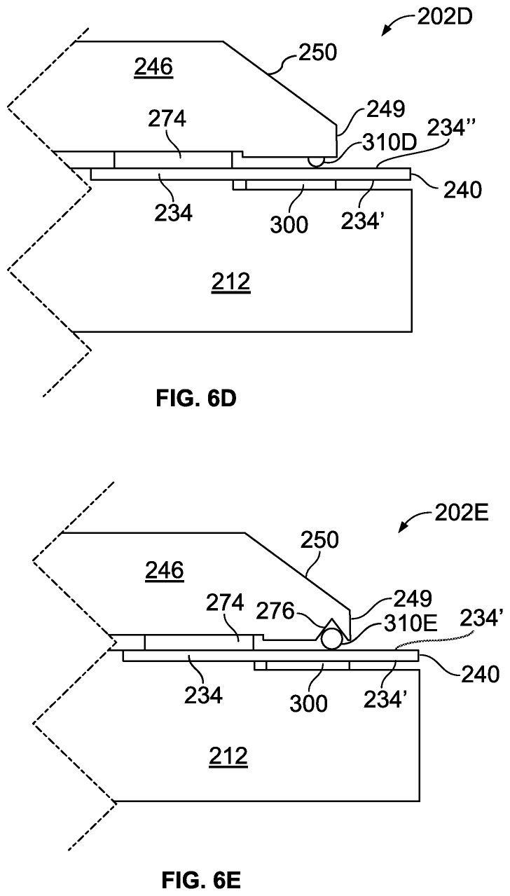

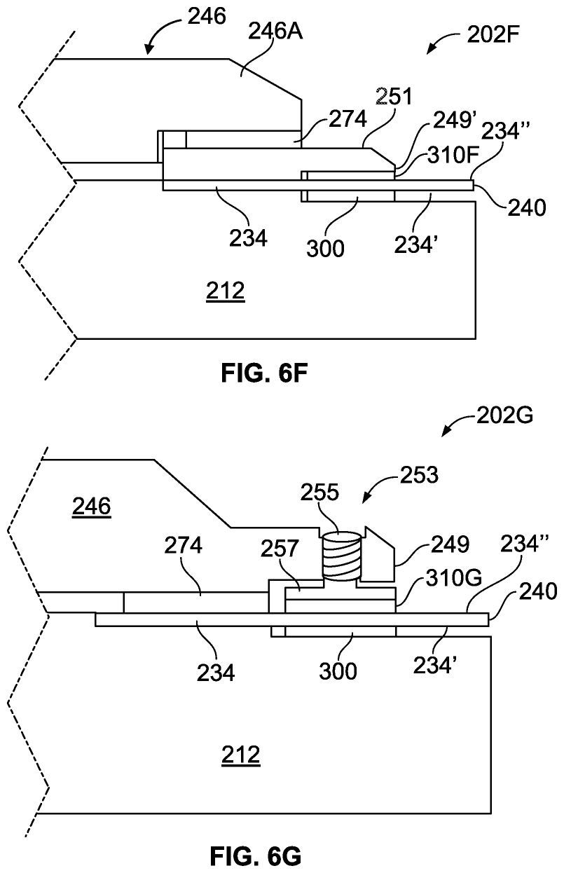

FIGS. 6A-6G illustrate examples of a blade support assembly 202A-202G in accordance with the present disclosure. Portions of the blade support assembly 202B-202G are eliminated in

FIGS. 6B-6G to illustrate other aspects in detail (unless indicated otherwise, the blade support assemblies 202B-202G may have the same or similar structure as the blade support assembly 202A depicted in FIG. 6A). As shown in FIGS. 6A-6G, each of the blade support assemblies 202A-202G comprises a clamp 246 that is coupled to the blade support 212 with a bolt 272 adjacent to a proximal edge 247 of the clamp 246. While a bolt 272 is shown, other attachment or clamping methods known in the art may be used, such as, for example, cam-actuated clamps or Destaco™ clamps. Each blade support assembly 202A-202G may further include a cutting surface comprising a blade 234 positioned between the clamp 246 and an outer surface of the blade support 212. As discussed above, the blade 234 has a first side 234′, which faces the blade support 212, and a second side 234″, which is opposite the first side 234′. Each blade support assembly 202A-202G may have a pressure distribution material 274 positioned between the clamp 246 and the blade 234 and toward a proximal edge 239 of the blade 234. The pressure distribution material 274 may help to distribute pressure more evenly from the clamp 246 across the blade 234.

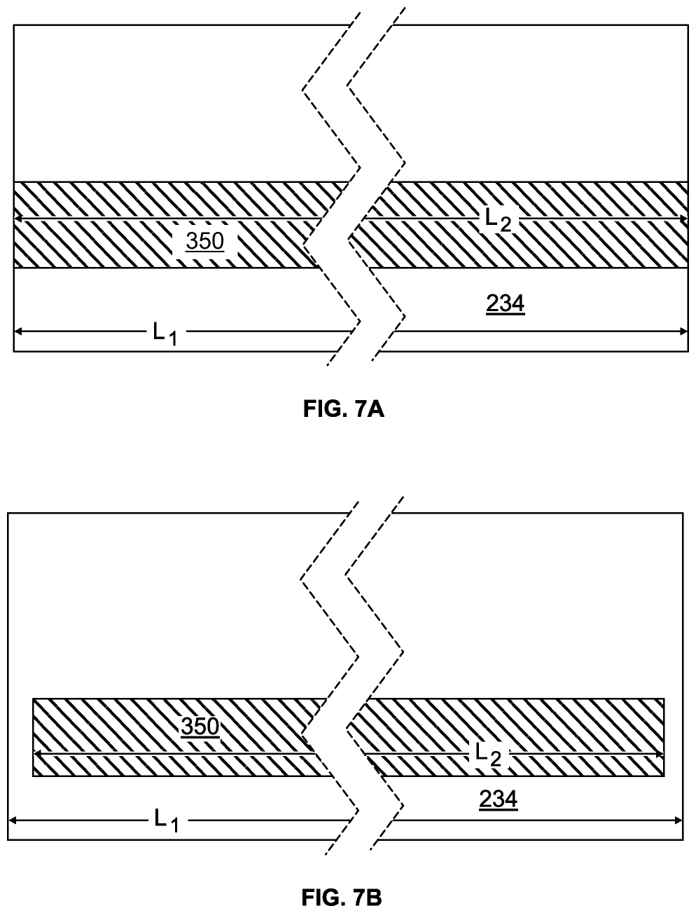

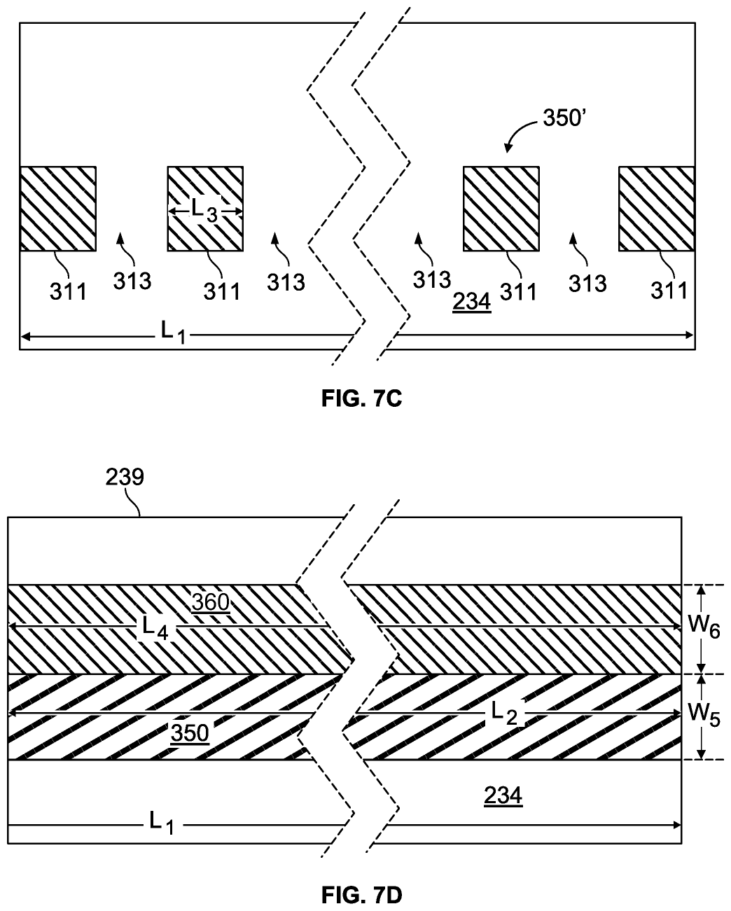

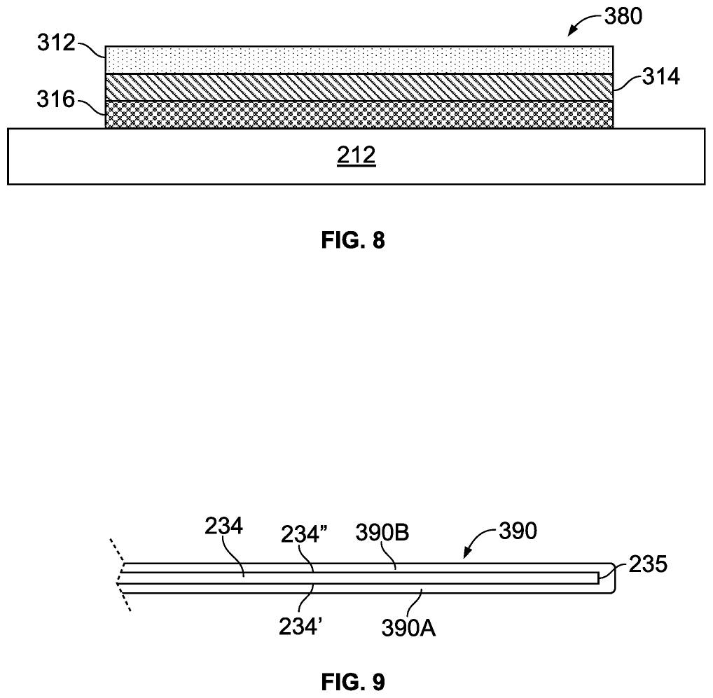

With continued reference to FIGS. 6A-6G, the blade support assembly 202A-202G may include at least one dampener member or portion of a dampener member 300 positioned on a first side 234′ of the blade and at least one dampener member or portion of a dampener member 310A-310G positioned on a second side 234″ of the blade 234, in which the first side 234′ of the blade faces the blade support 212 and the second side 234″ is opposite the first side 234′. In some examples, the dampener member(s) 300 may be discrete from the dampener member(s) 310A-310G. In other examples, the dampener members 300 and 310A-310G may comprise portions of a single dampener member. The clamp 246 may comprise an extended portion in the form of an extension 250 (FIGS. 6A-6E), a compression member 251 (FIG. 6F), or an adjustable pressure component 253 (FIG. 6G). The extension 250, compression member 251, and adjustable pressure component 253 extend beyond the pressure distribution material 274 and over a portion of the blade 234 to support dampening members 310A-310G. The extension 250, compression member 251, and adjustable pressure component 253 may each have a tapered thickness such that a thinnest portion of the extension 250, compression member 251, and adjustable pressure component 253 forms a distal edge 249 of the clamp 246 to ensure clearance between the distal edge 249 of the clamp 246 and the rotating anvil. As discussed below with reference to FIG. 6B, the blade support assembly 202A-202G may optionally have various recesses formed in the blade support 212 and/or the clamp 246 to help hold components in place. As discussed below with reference to FIGS. 7A-7D, the dampener members 300 and 310A-310G may extend along at least a portion of a longitudinal length L₁ of the blade 234. As discussed below with reference to FIG. 8, the dampener members 300 and 310A-310G may comprise the same material or may comprise different materials. Without intending to be bound by theory, it is believed that different dampener member thicknesses (see FIG. 6B), dampener member widths (see FIGS. 6C-6E), dampener member materials (see FIG. 8), and/or dampener member placement with respect to the proximal and distal edges 239, 240 of the blade 234 may influence the distribution of stresses on the blade 234.

With reference to the example shown in FIG. 6A, the blade support assembly 202A may include two dampener members 300, 310A. A first dampener member 300 may be positioned on the first side 234′ of the blade 234, e.g., between the blade 234 and the blade support 212. A second dampener member 310 may be positioned on the second side 234″ of the blade 234, e.g., between the blade 234 and the clamp 246. While a conventional clamp may extend over 45% of a blade, the clamp 246 and the extension 250 shown in FIG. 6A may extend over a greater portion of the blade 234. In some examples, the clamp 246 and the extension 250 may extend over an additional 30% of the blade, e.g., 76% of a width (not labeled) of the blade 234. Both dampener members 300, 310A may have a same width W₁ and may be aligned with the distal edge 249 of the clamp 246. The distal edge 249 of the clamp 246 may be the edge of the clamp 246 located adjacent to the distal edge 240 of the blade. A thickness T₁ of the first dampener member 300 may be substantially the same as a thickness T₂ of the second dampener member 310A. In some examples, the width W₁ of the dampener members 300, 310A may be 8.0 mm and the thickness T₁, T₂ of the dampener members 300, 310A, respectively, may be between 0.5 to 1.0 mm. In some examples, the thickness T₁, T₂ may be between 0.8 mm and 0.85 mm, and in other examples, thickness T₁, T₂ may be between 0.86 and 0.90 mm.

Interaction with the anvil (not shown; see FIG. 4) causes the distal edge 240 of the blade 234 in FIG. 6A to flex in a direction of the first side 234′ of the blade 234, i.e.., towards the blade support 212, as indicated with arrow A. Once the interaction ends, the distal edge 240 of the blade 234 rebounds in the direction of the second side 234″ of the blade 234, i.e., away from the blade support 212, as indicated with arrow B. Without intending to be bound by theory, it is believed that unlike the conventional perforating apparatus shown in FIG. 5B, which concentrates the tensile stresses during rebound in a small area of the blade 234 adjacent to the distal edge 249 of the clamp 246, the structure depicted in FIG. 6A more evenly distributes the tensile stresses during rebound across a larger area of the blade 234 due to the presence of the second dampener member 310A. In addition, the portion of the blade 234 in FIG. 6A that is unsecured, i.e., the portion of the blade 234 that extends beyond the distal edge 249 of the clamp 246, is reduced, as compared to FIGS. 5A and 5B, which reduces the portion of the blade 234 that rebounds. The structure with two dampener members 300, 310A is believed to help with reduction of the cracking and fatigue failure of the blade 234 adjacent to the distal edge 249 of the clamp 246 observed with the structure shown in FIGS. 5A and 5B.

In an alternative example of the blade support assembly 202B shown in FIG. 6B, the second dampener member 310B may have a thickness T₂ that is different from a thickness T₃ of the first dampener member 300. In some examples, the thickness T₂ of the second dampener member 310B may be less than the thickness T₃ of the first dampener member 300, as shown in the inset, labeled C. In other examples (not shown), the thickness of the second dampener member 310B may be greater than the thickness of the first dampener member 300. The thickness T₂ of the second dampener member 310B may be between 0.5 mm and 2 mm, and the thickness T₃ of the first dampener member 300 may be between 0.5 to 1.0 mm, preferably 0.8 mm to 0.85 mm. The example shown in FIG. 6B may provide similar benefits to the example shown in FIG. 6A with respect to improved distribution of tensile stresses.

In an alternative example of the blade support assembly 202C shown in FIG. 6C, the second dampener member 310C may have a width W₂ that is less than a width W₁ of the first dampener member 300. In some examples, the width W₁ of the first dampener member 300 may be 8 mm, and the width W₂ of the second dampener member 310C may be between 1 mm and 3 mm. The second dampener member 310C may be aligned with a distal edge 302 of the first dampener member 300 as shown. In other examples, the second dampener member 310C may be aligned with a proximal edge 304 of the first dampener member 300 as shown with dashed lines, or at any location between the distal edge 302 and the proximal edge 304 of the first dampener member 300.

As shown in FIG. 6C, one or more recesses may optionally be formed in the blade support 212 and in the clamp 246. The blade support 212 may include a first recess 280 that receives the blade 234. The proximal edge 239 of the blade 234 may be located adjacent to a proximal wall 281 of the recess 280. In some examples, the recess 280 may have a width W₃ of 13 mm. The blade support 212 may include a second recess 282 that is located distal to the first recess 280. A proximal wall 283 of the second recess 282 may be adjacent to a distal edge (not labeled) of the first recess 280. The first dampener member 300 may be located adjacent to the proximal wall 283 of the second recess 282 and may be spaced apart from the proximal wall 283 by a gap (not labeled) to allow for movement and expansion as the first dampener member 300 is compressed during flexing of the blade 234 toward the blade support 212. In some examples, the gap may be 1 mm. In some examples, the second recess 282 may have a width W₄ of 16 mm. It is believed that these recesses 280, 282 may help prevent movement of components during the cutting process. Furthermore, the clamp 246 may include one or more additional features to minimize movement of the second dampener member 310C during the cutting process, such as a recess (not shown) that receives the second dampener member 310C.

With continued reference to FIG. 6C, a thickness T₄ of the second recess 282 may be configured to receive the first dampener member 300 and to provide clearance for the blade 234 to flex, as described above. In some examples, the thickness T₄ of the second recess 282 may optionally be configured so that the first dampener member 300 is in a preloaded, i.e.., compressed state. Specifically, the thickness T₄ of the second recess 282 may be smaller than the thickness T₁ of the first dampener member 300, causing compression and preloading of the first dampener member 300 prior to blade 234 being secured by the clamp 246. In other examples, the thickness T₄ of the second recess 282 may be greater than the thickness T₁ of the first dampener member 300, so that there is a gap between the first surface 234′ of the blade and the first dampener member 300 and the first dampener member 300 is in an uncompressed state prior to the blade 234 being secured by the clamp 246. Alternatively, or in addition, the blade support assembly 202B may be configured so that the second dampener member 310C is in a preloaded, i.e.., compressed state, or in an uncompressed state.

With continued reference to FIG. 6C, a portion of the blade 234 near the distal edge 249 of the clamp 246 is secured, e.g., the portion of the blade 234 that is positioned beneath the second dampener member 310B, but a middle portion of the blade 234 positioned beneath the extension 250 is unsecured and may still undergo a small amount of flexing toward the second side 234″ of the blade 234, as shown in FIG. 5A. Without intended to be bound by theory, it is believed that the narrower dampener member 310C allows for the middle portion of the blade 234 to flex upward, which helps to distribute tensile stresses more evenly across the second side 234″ of the blade 234 during interaction with the anvil, while still minimizing the effects of rebound, as described above with respect to FIG. 6A.

In alternative examples of the blade support assemblies 202D. 202E shown in FIGS. 6D and 7E, at least a portion of a cross-section of the second dampener member 310D, 310E may be substantially circular. In the example shown in FIG. 6D, the second dampener member 310D may be hemispherical. The second dampener member 310D may be attached to the clamp 246 using adhesive or other attachment means known in the art. In the example shown in FIG. 6E, the second dampener member 310E may comprise an O-ring cord or gasket with a fully circular cross-section. The clamp 246 may include a recess 276 adjacent to the distal edge 249 of the clamp 246, and the second dampener member 310E may be positioned within the recess 276. The examples shown in FIGS. 6D and 6E may preserve some flexibility of the blade 234, as explained above with respect to FIG. 6C.

In an alternative example of the blade support assembly 202F shown in FIG. 6F, the clamp 246 may comprise an extended portion in the form of a compression member 251 that is separate from a main body 246A of the clamp 246, rather than being integral with the clamp 246 like the extension 250 shown in FIGS. 6A-6E. The blade 234 is positioned between the compression member 251 and an outer surface of the blade support 212, with first and second dampener members 300, 310F being positioned on first and second sides 234′, 234″, respectively, of the blade 234. The pressure distribution material 274 may be positioned between the main body of the clamp 246 and the compression member 251, with the compression member 251 being positioned between the main body of the clamp 246 and the blade support 212. Similar to the integral extension 250, the compression member 251 extends over the first and second dampener members 300, 310E. A distal edge 249′ of the compression member 251 may define a distal edge of the clamp 246, and the dampener members 300, 310E may be aligned with the distal edge 249′ of the compression member 251. The compression member 251 may be configured to separate compression of the second dampener member 251 from compression of the pressure distribution material 274 by the main body 246A of the clamp 246, such that the compression member 251 may provide more precise control of an amount of pressure applied to the second dampener member 310E and thus a level of compression or preloading of the second dampener member 310E, as explained above with respect to FIG. 6C.

In an alternative example of the blade support assembly 202G shown in FIG. 6G, the clamp 246 may comprise an extended portion comprising an adjustable pressure component 253. The first dampener member 300 may be positioned on the first side 234′ of the blade 234, and the second dampener member 310G may be positioned on the second side 234″ of the blade 234, e.g., between the blade 234 and the adjustable pressure component 253. As shown in FIG. 6G, the adjustable pressure component 253 may comprise a turn screw 255 coupled to a compression plate 257. Although FIG. 6G depicts one turn screw 255 and compression plate 257, it should be understood that the blade support assembly 202G may comprise a plurality of adjustable pressure components 253 positioned along a width (not shown; see FIG. 7A) of the blade 234. Unlike the configurations of FIGS. 6A-6F that apply a fixed pressure, the adjustable pressure component 253 of FIG. 6G allows the pressure applied to the second dampener member 310G to be adjusted independent of the pressure applied by the clamp 246, which allows more precise adjustment of the level of compression of the second dampener member 310G. Additionally, the pressure applied to the second dampener member 310G may be adjusted with the use of a wedge or a shim (not shown).

FIGS. 7A-7D show a top view of dampener members 350, 350′, 360 and a blade 234 in accordance with the present disclosure. For case of viewing, the clamp and the extension are not shown. The dampener members 350, 350′, 360 in FIGS. 7A-7D may represent any of the first and/or second dampener members 300 and 310A-310G depicted in FIGS. 6A-6G.

The blade 234 may comprise a longitudinal length L₁. In the example shown in FIG. 7A. a longitudinal length L₂ of the dampener member 350 may be substantially the same as the longitudinal length L₁ of the blade 234 within manufacturing tolerances, such that the dampener member 350 extends along substantially an entirety of the longitudinal length L₁ of the blade 234. In the example shown in FIG. 7B, the longitudinal length L₂ of the dampener member 350 may be less than the longitudinal length L₁ of the blade 234, such that longitudinal edges (not labeled) of the dampener member 350 are spaced inward from longitudinal edges (not labeled) of the blade 234. Additionally, while not shown, the dampener member (see reference numeral 300 in FIGS. 6A-6G) located between the blade 234 and the blade support may have a longitudinal length that is substantially the same as the longitudinal length L₁ of the blade 234 within manufacturing tolerances. Therefore, the dampener member 350 and the dampener member located between the blade 234 and the blade support may have different longitudinal lengths, as compared to each other.

In the example shown in FIG. 7C, the dampener member 350′ may be discontinuous along at least a portion of the longitudinal length L₁ of the blade 234 and may include a plurality of segments 311 separated by gaps 313. The segments 311 as a group may form the dampener member 350′. Each segment 311 may have a longitudinal length L₃ that may be less than the longitudinal length L₁ of the blade 234. A combined longitudinal length (not shown) of the segments 311 may give the dampener member 350′ an overall or combined longitudinal length that is less than the longitudinal length L₁ of the blade 234. Other than length, each segment 311 may have the same properties as the second dampener members 310A-310G described above with reference to FIGS. 6A-6G.

As shown in FIG. 7D, an additional dampener member 360 (also referred to herein as a third dampener member) may be positioned adjacent to the dampener member 350, in which the additional dampener member 360 is located closer to the proximal edge 239 of the blade 234. The additional dampener member 360 may be positioned immediately adjacent to, or in contact with, the dampener member 350, as shown. In other examples (not shown), the additional dampener member 360 may be spaced apart from the dampener member 350, e.g., in a direction toward the proximal edge 239 of the blade 234. The additional dampener member 360 may have a longitudinal length La that is the same as the longitudinal length L₁ of the blade 234 and/or the longitudinal length L₂ of the dampener member 350. Alternatively, the additional dampener member 360 may have a longitudinal length L₄ that is different from the longitudinal length L₁ of the blade 234 and/or the longitudinal length L₂ of the dampener member 350, such as the lengths shown in FIGS. 7B and 7C. In the example shown in FIG. 7D, the additional dampener member 360 may comprise a width W₆ that is substantially the same as a width W₅ of the dampener member 350. In other examples (not shown), the width W₆ of the additional dampener member 360 may be different from the width W₅ of the dampener member 350. The dampener members 350, 360 may comprise the same or different materials. In one example, the dampener member 350 may comprise a material with a lower modulus of elasticity, i.e., a softer and more compressible material, than the additional dampener member 360 to provide a desired stress profile across the blade 234.

FIG. 8 shows an example of a dampener member 380, which may represent any of the first and/or second dampener members 300, 310A-310G, 350, 350′, 360 depicted in FIGS. 6A-6G and 7A-7D. The dampener member 380 may have multiple layers including an adhesive layer 316 and one or more of a polymer layer 312 and a fiber layer 314. In the example shown in FIG. 8, the dampener member 380 is a three-layer configuration that is used as a second dampener member. in which the layers 312, 314, 316 are positioned so that the adhesive layer 316 faces an outer surface of the blade support 212 (i.e., the side of the blade support 212 that faces the blade 234), the fiber layer 314 is positioned above the adhesive layer 316, and the polymer layer 312 is positioned above the polymer fiber layer 314 and contacts the blade 234. While not shown, the dampener member 380 may be used as a first dampener member 300, in which the adhesive layer 316 faces an underside of the clamp 246 (i.e.., the side of the clamp 246 that faces the blade 234), the fiber layer 314 is positioned above the adhesive layer 316, and the polymer layer 312 is positioned above the fiber layer 314 and contacts the blade 234. The first dampener member 300 may comprise the same materials as the second dampener member 310 and/or one or more different materials. In all examples, the fiber layer 314, which may comprise one or more polymer and/or natural fibers, provides dampening of vibrations during operation and helps to distribute the tensile stresses generated during flexing and rebounding of the blade, as described herein. The dampener member 300, 310 may be a Rollin® Type 100 strip.

FIG. 9 is a side view of a portion of a dampener member 390 and a blade 234 in accordance with the present disclosure, in which a distal edge (not labeled) of the blade 234 is facing the viewer and a proximal edge (not shown) of the blade 234 is facing into the page. One longitudinal end 235 of the blade 234 is depicted. The dampener member 390 may wrap around the longitudinal end 235 of the blade 234 such that a first portion 390A of the dampener member 390 is positioned adjacent to a first side 234′ of the blade 234 (e.g., between the blade 234 and a blade support (not shown)) and a second portion 390B of the dampener member 390 is positioned adjacent to a second side 234″ of the blade 234 (e.g., between the blade 234 and a clamp (not shown)). The dampener member 390 may optionally wrap around a second longitudinal end (not shown) of the blade 234. The dampener member 390 may include any of the configurations shown in FIGS. 6A-6G and 7A-7D and may include any of the materials described with respect to FIG. 8.

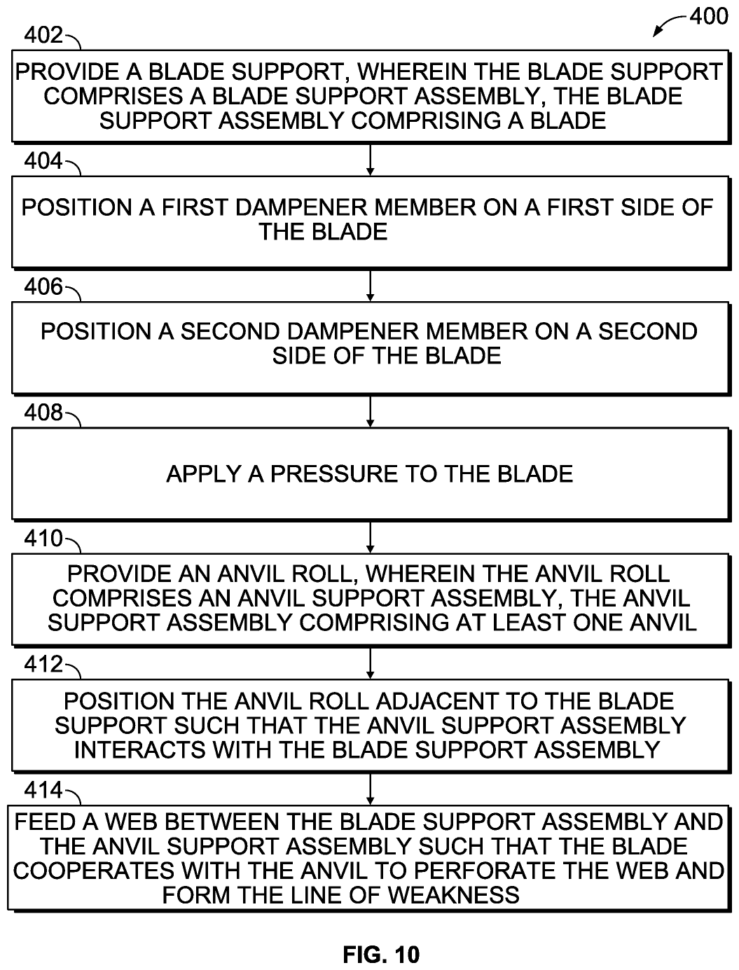

FIG. 10 illustrates an exemplary method 400 for cutting a substrate, in accordance with the present disclosure. At 402, a blade support is provided. As discussed above, the blade support comprises a blade support assembly and the blade support assembly comprises a blade. At 404, a first dampener member is positioned on a first side of the blade. At 406, a second dampener member is positioned on a second side of the blade. At 408, a pressure is applied to the blade by a clamp coupled to the blade support. The clamp may also apply pressure to a pressure distribution material and a second dampener member. At 410, an anvil roll is provided. As discussed above, the anvil roll comprises an anvil support assembly and the anvil support assembly comprises at least one anvil. At 412, the anvil roll is positioned adjacent to the blade support such that the anvil support assembly interacts with the blade support assembly. At 414, a web is fed between the blade support assembly and the anvil support assembly, specifically between a first cutting surface of the blade support assembly and a second cutting surface of the anvil support assembly, such that the blade cooperates with the anvil to perforate the web. As discussed above, when the first and second anvil support assemblies interact, the blade flexes in a direction of the first side of the blade. Then, the blade rebounds in a direction of the second side of the blade when the blade support assembly loses contact with the anvil support assembly.

Representative embodiments of the present disclosure described above can be described as follows:

A. A perforating apparatus comprising:
a blade support comprising a blade support assembly, wherein the blade support assembly comprises:
a clamp coupled to the blade support;
a blade positioned between the clamp and an outer surface of the blade support; and
a plurality of dampener members extending along at least a portion of a longitudinal length of the blade, wherein a first dampener member is positioned on a first side of the blade, wherein a second dampener member is positioned on a second side of the blade, and wherein the first side of the blade faces the blade support and the second side of the blade is opposite the first side of the blade.

B. The perforating apparatus of paragraph A, wherein the first dampener member and the second dampener member have similar widths.

C. The perforating apparatus of paragraph A, wherein a width of the first dampener member is greater than a width of the second dampener member.

D. The perforating apparatus of paragraphs A and B or paragraphs A and C, wherein a thickness of the first dampener member is the same as a thickness of the second dampener member.

E. The perforating apparatus of paragraph A and B or paragraphs A and C, wherein a thickness of the first dampener member is greater than a thickness of the second dampener member.

F. The perforating apparatus of paragraph A, paragraph B or C, and paragraph D or E, wherein the second dampener member extends along an entirety of the longitudinal length of the blade.

G. The perforating apparatus of paragraph A, paragraph B or C, and paragraph D or E, wherein a longitudinal length of the second dampener member is less than the longitudinal length of the blade.

H. The perforating apparatus of paragraph A, paragraph B or C, paragraph D or E, and paragraph F or G, wherein the second dampener member is discontinuous along at least a portion of the longitudinal length of the blade.

I. The perforating apparatus of paragraph A, paragraph B or C, paragraph D or E, paragraph F or G, and paragraph H, wherein the first and second dampener members comprise a same material.

J. The perforating apparatus of paragraph A, paragraph B or C, paragraph D or E, and paragraph F or G, wherein the first and second dampener members comprise a different material.

K. The perforating apparatus of paragraph A, paragraph B or C, paragraph D or E, paragraph F or G, and paragraph I or J, further comprising a third dampener member, wherein the second dampener member and the third dampener member comprise a same material.

L. The perforating apparatus of paragraph A, paragraph B or C, paragraph D or E, paragraph F or G, and paragraph I or J, further comprising a third dampener member, wherein the second dampener member comprises a material having a modulus of elasticity that is lower than a modulus of elasticity of a material of the third dampener member.

M. The perforating apparatus of paragraph A, paragraph B or C, paragraph D or E, paragraph F or G, and paragraph I or J, further comprising a third dampener member, wherein the second dampener member comprises a material having a compressibility that is greater than a compressibility of a material of the third dampener member.

N. The perforating apparatus of paragraph A, paragraph B or C, paragraph D or E, paragraph F or G, paragraph I or J, and paragraph K, L, or M, wherein at least a portion of a cross-section of the second dampener member is circular.

O. The perforating apparatus of paragraph N, wherein the clamp comprises a recess and the second dampener member is positioned in the recess.

P. The perforating apparatus of paragraph A, paragraph B or C, paragraph D or E, paragraph For G, paragraph I or J, paragraph K, L, or M, and paragraphs N and O, wherein the blade support assembly further comprises a first cutting surface, the perforating apparatus further comprising:
a frame; and
a housing rotatably supported by the frame;
an anvil roll rotatably supported by the housing, the anvil roll comprising an anvil support assembly with a second cutting surface adapted to intermittently contact the first cutting surface of the blade support assembly.

Q. The perforating apparatus of paragraph A, wherein the clamp comprises an extension, the blade being positioned between the extension and an outer surface of the blade support, and wherein the extension extends over the first dampener member and the second dampener member.

R. The blade support assembly of paragraph Q, wherein the extension has a tapered thickness such that a thinnest portion of the extension forms a distal edge of the clamp.

S. The blade support assembly of paragraphs Q and R, wherein the extension is integral with the clamp.

T. The blade support assembly of paragraphs Q and R, wherein the clamp comprises a main body and the extension comprises a compression member, wherein the compression member is a separate component from the main body.

U. The blade support assembly of paragraphs Q and R and paragraph S or T, wherein the extension comprises an adjustable pressure component.

V. A method for forming a line of weakness in a substrate, the method comprising: providing a blade support, wherein the blade support comprises a blade support assembly, the blade support assembly comprising a blade;
positioning a first dampener member on a first side of the blade;
positioning a second dampener member on a second side of the blade;
applying, by a clamp coupled to the blade support, a pressure to the blade;
providing an anvil roll, wherein the anvil roll comprises an anvil support assembly, the anvil support assembly comprising at least one anvil;
positioning the anvil roll adjacent to the blade support such that the anvil support assembly interacts with the blade support assembly; and
feeding a web between the blade support assembly and the anvil support assembly such that the blade cooperates with the anvil to perforate the web and form the line of weakness,
wherein the blade flexes in a direction of the first side of the blade when the blade support assembly and the anvil support assembly interact, and
wherein the blade rebounds in a direction of the second side of the blade when the blade support assembly loses contact with the anvil support assembly.

W. The method of paragraph V, wherein the clamp comprises an adjustable pressure component, the method further comprising:
adjusting, by the adjustable pressure component, the pressure applied to the blade.

X. The method of paragraphs V and W, further comprising: prior to applying the pressure to the blade, providing at least one of the first dampener member or the second dampener member in a preloaded state.

Y. A blade support comprising a blade support assembly, the blade support assembly comprising:
a clamp coupled to the blade support;
a blade; and
a dampener member comprising a first portion positioned on a first side of the blade and a second portion positioned on a second side of the blade, wherein the first side of the blade faces the blade support and the second side of the blade is opposite the first side of the blade.

The illustrations presented herein are not intended to be actual views of any particular substrate, apparatus (e.g., device, system, etc.), or method, but are merely idealized and/or schematic representations that are employed to describe and illustrate various examples of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular examples of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A perforating apparatus comprising:
a blade support comprising a blade support assembly, wherein the blade support assembly comprises:
a clamp coupled to the blade support;
a blade positioned between the clamp and an outer surface of the blade support; and
a plurality of dampener members extending along at least a portion of a longitudinal length of the blade, wherein a first dampener member is positioned on a first side of the blade, wherein a second dampener member is positioned on a second side of the blade, and wherein the first side of the blade faces the blade support and the second side of the blade is opposite the first side of the blade.

2. The perforating apparatus of claim 1, wherein a width of the first dampener member is the same as or greater than a width of the second dampener member.

3. The perforating apparatus of claim 1, wherein a thickness of the first dampener member is the same as or greater than a thickness of the second dampener member.

4. The perforating apparatus of claim 1, wherein a length of the second dampener member is the same as or less than the longitudinal length of the blade.

5. The perforating apparatus of claim 1, wherein the second dampener member is discontinuous along at least a portion of the longitudinal length of the blade.

6. The perforating apparatus of claim 1, wherein the first and second dampener members comprise a same or different material.

7. The perforating apparatus of claim 1, further comprising a third dampener member, wherein the second dampener member comprises a material having a modulus of elasticity that is less than a modulus of elasticity of a material of the third dampener member.

8. The perforating apparatus of claim 1, further comprising a third dampener member, wherein the second dampener member comprises a material having a compressibility that is greater than a compressibility of a material of the third dampener member.

9. The perforating apparatus of claim 1, wherein at least a portion of a cross-section of the second dampener member is circular.

10. The perforating apparatus of claim 9, wherein the clamp comprises a recess and the second dampener member is positioned in the recess.

11. The perforating apparatus of claim 1, wherein the blade support assembly further comprises a first cutting surface, the perforating apparatus further comprising:
a frame;
a housing rotatably supported by the frame; and
an anvil roll rotatably supported by the housing, the anvil roll comprising an anvil support assembly with a second cutting surface adapted to intermittently contact the first cutting surface of the blade support assembly.

12. The perforating apparatus of claim 1, wherein the clamp comprises an extension, the blade being positioned between the extension and an outer surface of the blade support, and wherein the extension extends over the first dampener member and the second dampener member.

13. The blade support assembly of claim 12, wherein the extension has a tapered thickness such that a thinnest portion of the extension forms a distal edge of the clamp.

14. The blade support assembly of claim 12, wherein the extension is integral with the clamp.

15. The blade support assembly of claim 12, wherein the clamp comprises a main body and the extension comprises a compression member, wherein the compression member is a separate component from the main body.

16. The blade support assembly of claim 12, wherein the extension comprises an adjustable pressure component.

17. A method for forming a line of weakness in a substrate, the method comprising:
providing a blade support, wherein the blade support comprises a blade support assembly, the blade support assembly comprising a blade;
positioning a first dampener member on a first side of the blade;
positioning a second dampener member on a second side of the blade;
applying, by a clamp coupled to the blade support, a pressure to the blade;
providing an anvil roll, wherein the anvil roll comprises an anvil support assembly, the anvil support assembly comprising at least one anvil;
positioning the anvil roll adjacent to the blade support such that the anvil support assembly interacts with the blade support assembly; and
feeding a web between the blade support assembly and the anvil support assembly such that the blade cooperates with the anvil to perforate the web and form the line of weakness,
wherein the blade flexes in a direction of the first side of the blade when the blade support assembly and the anvil support assembly interact, and
wherein the blade rebounds in a direction of the second side of the blade when the blade support assembly loses contact with the anvil support assembly.

18. The method of claim 17, wherein the clamp comprises an adjustable pressure component, the method further comprising:
adjusting, by the adjustable pressure component, the pressure applied to the blade.

19. The method of claim 17, further comprising:
prior to applying the pressure to the blade, providing at least one of the first dampener member or the second dampener member in a preloaded state.

20. A blade support comprising a blade support assembly, the blade support assembly comprising:
a clamp coupled to the blade support;
a blade; and
a dampener member comprising a first portion positioned on a first side of the blade and a second portion positioned on a second side of the blade, wherein the first side of the blade faces the blade support and the second side of the blade is opposite the first side of the blade.
